(19) United States
(12) Patent Application Publication
(10) Pub. No.: US 2009/0273509 A1
(43) Pub. Date: Nov. 5, 2009

(54) MICROWAVE IMAGING SYSTEM AND METHOD

(76) Inventor: LAWRENCE FULLERTON, New Hope, AL (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/436,044

(22) Filed: May 5, 2009

Related U.S. Application Data
(60) Provisional application No. 61/050,566, filed on May 5, 2008.

(51) Int. Cl. G01S 13/90

(52) U.S. Cl. 342/25 A

(57) ABSTRACT

A system and method for using microwaves for forming a three-dimensional image of a target are disclosed. One or more RF waveforms are emitted toward the target on a plurality of frequencies from an array of antennas positioned around the target. Each antenna in the array of antennas is selectively controlled to receive multi-frequency RF energy from one or more emitted RF waveforms that is scattered by the target. The multi-frequency RF energy is coherently digitized as reflection data. The reflection data is then processed to form a three-dimensional image of an area in proximity of the platform and including the target.

### CROSS REFERENCE TO RELATED APPLICATIONS

This application claims the benefit of priority under 35 U.S.C. §119 to U.S. Provisional Patent Application Ser. No. 61/050,566, filed on May 5, 2008, entitled, “Microwave Imaging System and Method”, the entire disclosures of which is incorporated by reference herein.

### BACKGROUND

This document relates to imaging systems and methods, and more particularly to a microwave imaging system and method for efficient, fast and accurate imaging of a target object within a zone or area.

Synthetic-aperture radar (SAR) is a form of radar in which in which a number of low-directivity, small stationary antennas are scattered over an area near or around the target area. Echo waveforms received at the different antenna positions are post-processed to resolve an image of the target. SAR can only be implemented by moving one or more antennas over relatively immobile targets, by placing multiple stationary antennas over a relatively large area, or combinations thereof. SAR has seen wide applications in remote sensing and mapping.

### SUMMARY

This document discloses a microwave imaging system for forming an image of a target using emitted radio frequency waveforms at a number of frequencies.

In some implementations, a microwave imaging system includes an array of antennas for emitting and receiving RF waveforms, a switching matrix that controls and switches the array of antennas, and a receiver for receiving reflected RF waveforms from at least one antenna of the array of antennas. The microwave imaging system further includes a digitizer for digitizing the received reflected RF waveforms to produce digitized RF waveforms, an equalizer for equalizing the digitized RF waveforms in both amplitude and phase domains to produce an ideal impulse response signal, and an imaging module executing a synthetic aperture radar (SAR) imaging algorithm for creating a three-dimensional SAR image of the ideal impulse response signal.

In other implementations, a system for forming a three-dimensional image of a target includes a platform for receiving the target, and an array of antennas arranged around the platform so as to enable each antenna in the array of antennas to emit RF waveforms toward the target on a plurality of frequencies, each antenna being controlled to selectively receive multi-frequency RF energy from one or more emitted RF waveforms that is scattered by the target. The system further includes an image processing subsystem that coherently digitizes and stores the multi-frequency RF energy as reflection data, and processes the reflection data to form a three-dimensional image of an area in proximity of the platform and including the target.

In yet other implementations, a method for forming a three-dimensional image of a target is disclosed. The method includes the steps of emitting one or more RF waveforms toward the target on a plurality of frequencies from an array of antennas positioned around the target, selectively controlling each antenna in the array of antennas to receive multi-frequency RF energy from one or more emitted RF waveforms that is scattered by the target, coherently digitizing the multi-frequency RF energy as reflection data, and processing the reflection data to form a three-dimensional image of an area in proximity of the platform and including the target.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a functional block diagram of a microwave imaging system.

FIG. 2 illustrates an array of antennas positioned in a zone around a target to be imaged.

FIG. 3 is a flowchart of a microwave imaging method.

Like reference symbols in the various drawings indicate like elements.

### DETAILED DESCRIPTION

This document describes a microwave imaging system and method. The microwave imaging system and method includes a coherent, wideband radar capable of operation in monostatic and bistatic modes.

In one preferred exemplary embodiment, only the monostatic mode is used. A number of wideband antennas are positioned roughly around a target to be scanned, and each antenna is used in both transmission and reception of RF energy. In monostatic mode each antenna emits a radio frequency (RF) waveform on a plurality of frequencies, and the energy scattered from the target is coherently digitized and stored for subsequent analysis. This process is repeated for each antenna. When all of the antennas have captured the reflected waveforms, each waveform then is equalized in amplitude and phase to produce an ideal impulse response version of the data. Next an inverse Fourier transform is performed separately on each of the equalized multi-frequency waveforms stored from each antenna. This produces a time domain version of the reflection data whose time resolution and noise bandwidth is a function of both the frequency range over which the frequency is varied, and its dwell time at each frequency. These parameters are set to yield a result as needed for a given scenario. For example a resulting time window of 20 ns corresponds to a 10 foot range. The time domain waveforms are then used to produce a three dimensional synthetic aperture radar (SAR) image of the area within the field of view of the antennas. This SAR is produced by using a back-projection algorithm.

In the bistatic mode the same procedure is performed except that separate transmit and receive antennas used. That is, one antenna is used to transmit a given frequency and one or more other antennas are used to receive the reflected waveforms. In exemplary implementations, each antenna is used to transmit every frequency over a range of frequencies and all the antennas, including the one transmitting the waveform, is also used to receive the reflected waveforms.

In preferred implementations, a microwave imaging system generally includes a target platform subsystem, an antenna array in an arrangement around the target platform subsystem and adapted to enable each antenna to emit an RF waveform toward a target on the target platform subsystem and receive selective RF waveforms, and an image processing subsystem for processing the received RF waveforms according to a SAR algorithm to form a three-dimensional image of the target.

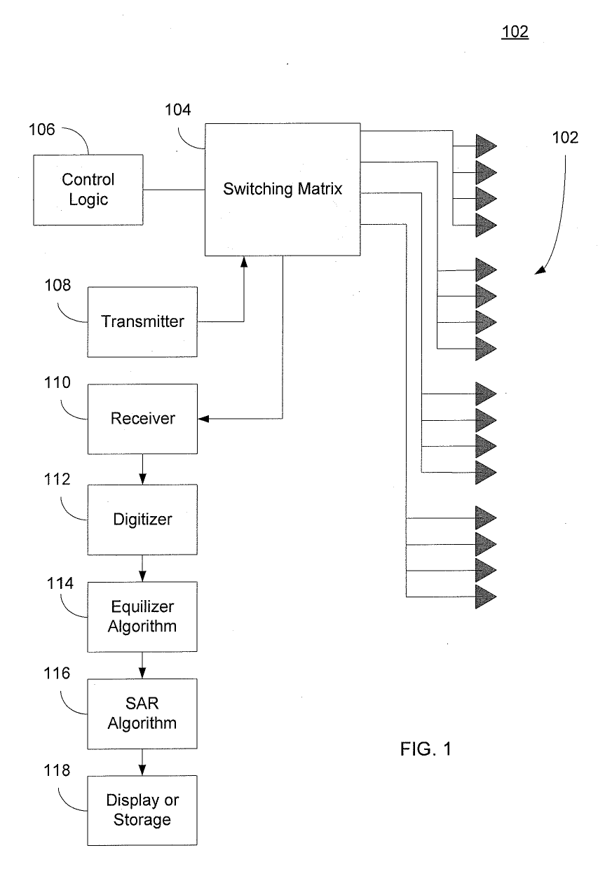

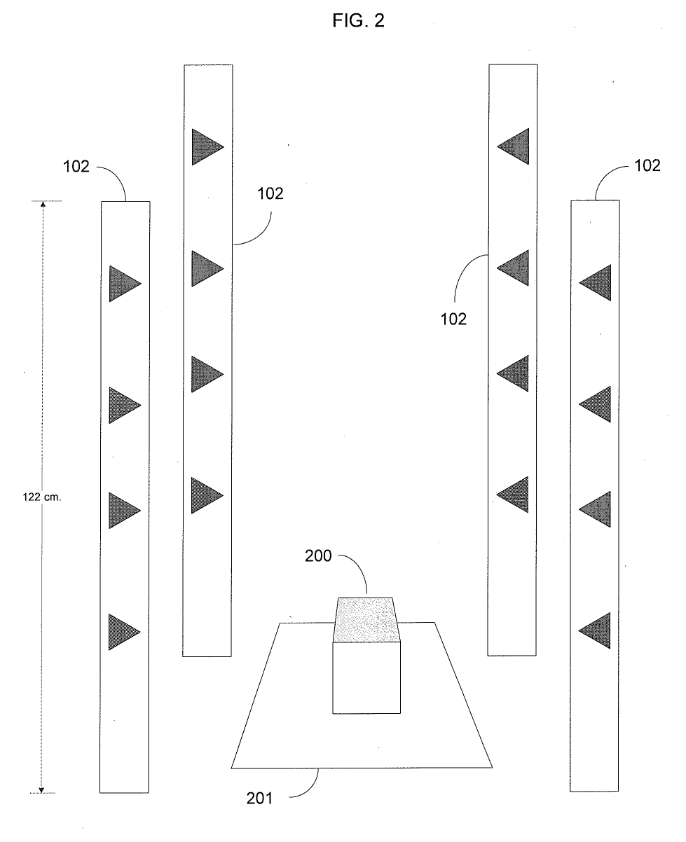

FIG. 1 is a functional block diagram of a microwave imaging system 100 The system 100 includes an array of wideband antennas 102 that are switched and operated by switching matrix 104. As illustrated generally in FIG. 2, the antennas 102 are positioned roughly around a target 200 to be scanned. The target 200 can be positioned on a platform 201 or stage area, which can also include a conveyance mechanism such as a belt or motorized transporter. The target 200 can be an item of cargo, such as boxes, bags, a person or persons, or any other object that can be carried by a common carrier such as a ship, plane, truck, or car, or by any other transportation mechanism. The target 200 can also be food items or other goods such as lumber.

In an exemplary implementation, each antenna of the array of antennas 102 is used in both transmission and reception of RF energy. The switching matrix 104 is controlled by control logic 106. A transmitter 108 transmits signals to the switching matrix 104 for transmitting every frequency over a range of frequencies over all of the antennas in the array 102. Each antenna in the array of antennas 102 receives the reflected waveforms in a receiver 110 connected through switching matrix.

Each antenna in the array of antennas 102 emits an RF waveform on a plurality of frequencies, and the energy scattered from the target is coherently digitized and stored for subsequent analysis. This process is repeated for each antenna in the array of antennas 102 When all of the antennas 102 have captured the reflected waveforms by receiver 110, each waveform then is digitized by digitizer 112, and equalized in amplitude and phase by equalizer 114 to produce an ideal impulse response version of the data.

Next, the inverse Fourier transform is performed separately on each of the equalized multi-frequency waveforms stored from each antenna by SAR algorithm 116. This produces a time domain version of the reflection data whose time resolution and noise bandwidth is a function of the frequency range over which the frequency is varied and its dwell time at each frequency. These parameters are set to yield a result as needed for a given scenario. For example a resulting time window of 20 ns corresponds to a 10 foot range. The time domain waveforms are then used to produce a three-dimensional SAR image of the area within the field of view of the antennas, and the target 200 therein, using a back-projection algorithm, for display on a display 118 or storage in memory 118.

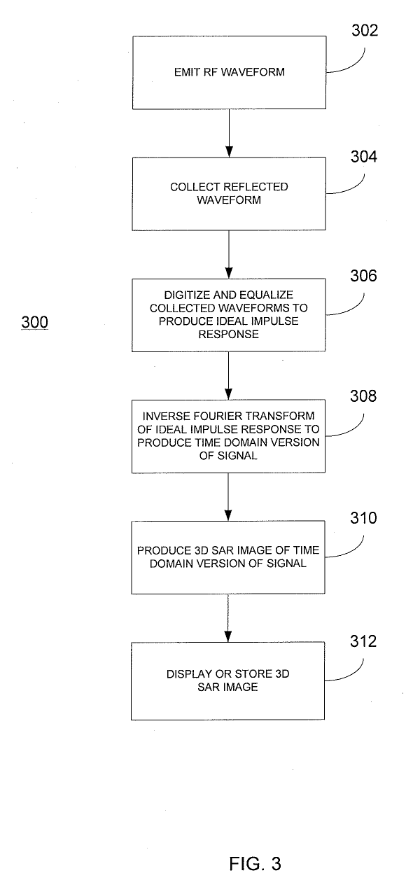

FIG. 3 illustrates a microwave imaging method 300, which can be executed by a suitable imaging system such as system 100 described above. At 302, each antenna of an array of antennas emits an RF waveform. The array of antennas are preferably arranged around a zone that contains a target to be imaged. At 304, each reflected waveform is collected. The reflected waveform represents energy that is reflected by the target within the zone. Once every component of the reflected waveform is collected, i.e. from each antenna in the array, the reflected waveform is digitized and equalized at 306 to produce an ideal impulse response. The waveform is equalized in amplitude and phase to produce the ideal impulse response version of the data.

At 308, the inverse Fourier transform is performed separately on each of the equalized multi-frequency waveforms received from each antenna, to produce a time domain version of the reflected data. The reflected data has time resolution and a noise bandwidth that is a function of the frequency range over which the frequency is varied, as well as a function of its dwell time at each frequency. These parameters are set to yield a result as needed for a given scenario. For example a resulting time window of 20 ns corresponds to a 10 foot range.

The time domain waveforms are then used to produce a three-dimensional SAR image of the zone and target within the field of view of the antennas, at 310. This SAR is preferably produced by using a back-projection algorithm, but other imaging algorithms can be suitably used. At 312, the three-dimensional SAR image is processed for being displayed on a display screen, stored in a memory, or both. The three-dimensional SAR image can also be transmitted over a network to other workstations, displays or memories.

Some or all of the functional operations described in this specification, as particularly described in the attached document, can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Although a few embodiments have been described in detail above, other modifications are possible. The logic flow depicted in FIG. 3 does not require the particular order shown, or sequential order, to achieve desirable results. Other embodiments may be within the scope of the following claims.

1. A microwave imaging system comprising:
an array of antennas for emitting and receiving RF waveforms;
a switching matrix that controls and switches the array of antennas;
a receiver for receiving reflected RF waveforms from at least one antenna of the array of antennas;
a digitizer for digitizing the received reflected RF waveforms to produce digitized RF waveforms;
an equalizer for equalizing the digitized RF waveforms in both amplitude and phase domains to produce an ideal impulse response signal; and
an imaging module executing a synthetic aperture radar (SAR) imaging algorithm for creating a three-dimensional SAR image of the ideal impulse response signal.

2. The system in accordance with claim 1, wherein the array of antennas are fixed in an arrangement around an area that is adapted to receive a target.

3. The system in accordance with claim 1, wherein the SAR imaging algorithm includes a back-projection SAR algorithm.

4. The system in accordance with claim 1, further comprising a display to display the three-dimensional SAR image.

5. The system in accordance with claim 1, wherein the switching matrix controls each antenna of the array of antennas in a monostatic mode.

6. The system in accordance with claim 1, wherein the switching matrix controls each antenna in the array of antennas in a bistatic mode.

7. A system for forming a three-dimensional image of a target, the system comprising:
a platform for receiving the target;
an array of antennas arranged around the platform so as to enable each antenna in the array of antennas to emit RF waveforms toward the target on a plurality of frequencies, each antenna being controlled to selectively receive multi-frequency RF energy from one or more emitted RF waveforms that is scattered by the target; and
an image processing subsystem that coherently digitizes and stores the multi-frequency RF energy as reflection data, and processes the reflection data to form a three-dimensional image of an area in proximity of the platform and including the target.

8. The system in accordance with claim 7, wherein the image processing subsystem includes a processor configured to:
equalize the multi-frequency RF energy in amplitude and phase to produce an ideal impulse response signal; and
perform an inverse Fourier transform separately on each equalized multi-frequency waveform to produce a time domain version of the reflection data.

9. The system in accordance with claim 8, wherein the processor is configured to produce the time domain version of the reflection data that has a time resolution and noise bandwidth that is a function of both the frequency range over which the frequency is varied and a dwell time at each frequency.

10. The system in accordance with claim 8, wherein the processor is further configured to:
perform a SAR algorithm on the time domain version of the reflection data to produce the three dimensional image.

11. The system in accordance with claim 10, further comprising a display in communication with the image processing subsystem, the display configured to display the three dimensional image.

12. The system in accordance with claim 7, further comprising a storage medium to store the three dimensional image.

13. The system in accordance with claim 12, wherein the storage medium includes a relational database to store the three dimensional image with the reflection data.

14. A method for forming a three-dimensional image of a target, the method comprising:
emitting one or more RF waveforms toward the target on a plurality of frequencies from an array of antennas positioned around the target;
selectively controlling each antenna in the array of antennas to receive multi-frequency RF energy from one or more emitted RF waveforms that is scattered by the target;
coherently digitizing the multi-frequency RF energy as reflection data; and
processing the reflection data to form a three-dimensional image of an area in proximity of the platform and including the target.

15. The method in accordance with claim 14, wherein processing the reflection data further comprises:
equalizing the multi-frequency RF energy in amplitude and phase to produce an ideal impulse response signal; and
performing an inverse Fourier transform separately on each equalized multi-frequency waveform to produce a time domain version of the reflection data.

16. The method in accordance with claim 15, wherein the time domain version of the reflection data is produced to have a time resolution and noise bandwidth that is a function of both the frequency range over which the frequency is varied and a dwell time at each frequency.

17. The method in accordance with claim 15, further comprising performing a SAR algorithm on the time domain version of the reflection data to produce the three dimensional image.

18. The method in accordance with claim 17, further comprising displaying the three dimensional image on a display.

19. The method in accordance with claim 17, further comprising storing the three dimensional image in a storage medium.

20. The method in accordance with claim 17, further comprising transmitting the three dimensional image to a client computer via a communications network.
